(19) United States
(12) Patent Application Publication
(10) Pub. No.: US 2007/0165400 A1
(43) Pub. Date: Jul. 19, 2007

(54) Light unit and method for generating light rays

(76) Inventor: Patrick Linder, Mandach (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/589,118

(22) PCT Filed: Feb. 9, 2005
(86) PCT No.: PCT/CH05/00070

§ 371 Date: Aug. 11, 2006

(30) Foreign Application Priority Data
Feb. 11, 2004 (CH) PCTCH200400079

(51) Int. Cl. F21V 9/00

(52) U.S. Cl. 362/231

(57) ABSTRACT

A light unit for generating light rays with differing wavelengths is disclosed. The light unit has a light source unit (34), a mirror unit (80), a carrier unit (30), an output window (50) comprising an opening (60) and a pressure generation unit (12). The light source unit (34) and the pressure generation element (32) are contained in the carrier unit (30), which has a longitudinal axis (40) that runs substantially parallel to the generated light rays and the mirror unit (80) and the output window (50) are located at opposite ends of the carrier unit (30). In addition, the pressure generation unit (32) generates a force that acts on the light source unit (34). The mirror unit (80) and/or the output window (50) can be displaced in relation to the carrier unit (30) and/or tilted in relation to the longitudinal axis (40) by at least one displacement element (52, . . . , 56), in conjunction with the force that is exerted on the light source unit (34) by the pressure generation element (32). This permits the wavelength of the light rays to be adjusted over a wide range.

### RELATED APPLICATION

This application is a U.S. national phase filing under 35 U.S.C. §371 of International Application No. PCT/CH2005/000070 filed Feb. 9, 2005, which claims priority of International Application No. PCT/CH2004/00079 filed Feb. 11, 2004.

### TECHNICAL FIELD

The present invention relates to a light unit for generating light beams having various wavelengths and a method for generating light beams.

### BACKGROUND

The generation of laser beams having various wavelengths using the same laser unit is known in and of itself. Thus it has already been proposed to split the laser beam of a white light laser with the aid of filters or prisms in order in this way to extract the desired color components, that is, wavelengths. It is further known to alter the dimensions of the resonator present in laser units with the aid of a corresponding mechanical system, so that the wavelength of the generated laser light can also be altered, but only from one mode to another. In relation to white light or respectively colored light laser, reference is made to a press release from the University of Bonn, Germany, dated Sep. 16, 2003. Therein is described a new laser with which white light can be generated in simple fashion and at low cost. The white light is decomposed into the color components with the aid of a suitable prism, it then being possible to select the required color. In relation to the first-named technique, reference is made to the publication by Jeff Hecht entitled “Understanding Lasers” (IEEE Press, 1992, pp. 296-297).

The known laser units, however, exhibit unsatisfactory properties, specifically both with respect to the possibility of being able to set a certain wavelength and also with respect to the coherence of the laser beams obtained.

Further, laser units are known in which, with the aid of a pressure element, a lateral pressure is exerted on the active layer of a semiconductor in order to alter the wavelength of the emitted light. In this connection, reference is made to the following publications:
FR-1 382 706;
JP-63 066 983;
publication by S. Komiyama and S. Kuroda titled “Remarkable effects of uniaxial stress on the far-infrared laser emission in p-type Ge” (Physical Review, B. Condensed Matter, American Institute of Physics, New York, U.S.A., Vol. 38, No. 2, Jul. 15, 1988, pages 1274 to 1275).

With known laser units, the wavelength can be varied only within a relatively small range, as is inferred in particular from the results described in the last-named publication.

Further, there are known laser units in which the wavelength is varied by displacement of one or a plurality of mirrors. In this connection, reference is made to DE-42 15 797 A1, U.S. Pat. No. 6,396,083 B1 or US-2003/0012249 A1 as being representative. Even in the case of these known laser units, however, the wavelength can be varied only within a certain range, specifically by selecting one mode of the laser.

### SUMMARY OF INVENTION

It is therefore a goal of the present invention to identify a light unit that does not exhibit the aforesaid disadvantages.

This goal is achieved through the light unit of the invention for generating light beams having various wavelengths, the light unit including a light source unit, a mirror unit, a support unit, an exit window having an opening, and a pressure-generating element, the light source unit and the pressure-generating element being contained in the support unit, which exhibits a longitudinal axis running substantially parallel to the generated light beams, the mirror unit and the exit window being arranged on opposite ends of the support unit, and a force being generated with the pressure-generating element, which force acts on the light source unit, wherein at least one of the mirror unit and the exit window is at least one of displaceable relative to the support unit and tiltable relative to the longitudinal axis by at least one displacement element in dependence on the force generated by the pressure-generating element on the light source unit. Advantageous developments of the invention and a method for generating light beams having various wavelengths are discussed below.

The invention has the following advantages: In that the mirror unit and/or the exit window are displaceable relative to the support unit and/or tiltable relative to the longitudinal axis by at least one displacement element in dependence on the force generated on the light source unit by the pressure-generating element, the possibility of being able to set the wavelength of the light beams over a wide range is created. Thus an exact setting of the wavelength of a light unit is possible through the combination of the setting of the wavelength via the force on the light source unit with simultaneous displacement of the exit window and/or the mirror unit along the longitudinal axis of the support unit, which setting far surpasses former setting capabilities.

If, in addition, a laser diode unit is used as the light source unit, the prerequisite is satisfied for the first time for being able to obtain maximally coherent light by setting the spacing between the mirror unit and the exit window as a multiple of half the wavelength set via the pressure-generating element.

In what follows, the invention is described in greater detail with reference to the embodiments illustrated in the drawings. These are exemplary embodiments that aid in understanding the subjects claimed in the claims.

### BRIEF DESCRIPTION OF DRAWINGS

FIG. 1A depicts, in schematic and perspective representation, a part of a light unit, one cutting plane lying parallel to a longitudinal axis and another cutting plane lying transversely to the longitudinal axis;

FIG. 1B depicts, in schematic and perspective representation according to FIG. 1A, a part of a further embodiment of a light unit;

FIG. 2 depicts an exit window for employment in the part of the light unit illustrated in FIG. 1A or 1B;

FIG. 3 depicts the exit window of FIG. 2 in a section parallel to the longitudinal axis according to FIG. 1A or 1B;

FIG. 4 depicts the fully assembled light unit according to FIGS. 1A, 1B, 2, and 3;

FIGS. 5A and 5B each depict a section transverse to the longitudinal axis of a light unit; and

FIG. 6 depicts a schematic representation of a variant embodiment according to the invention, in which a mirror unit and an exit window are always arranged centrally in relation to a light source unit.

### DETAILED DESCRIPTION

In the discussion that follows, a laser unit is described as a special case of a light unit. The light source is here defined such that it does not necessarily generate light beams that satisfy the conditions imposed on laser beams. Not so, in particular, even when—as provided in one embodiment—a laser diode unit is used as light source unit in the light source. Thus, for the explanation of specific embodiments in which laser beams are not generated, the term “laser unit” can basically be replaced by “light unit” without in this way altering the principle according to the invention.

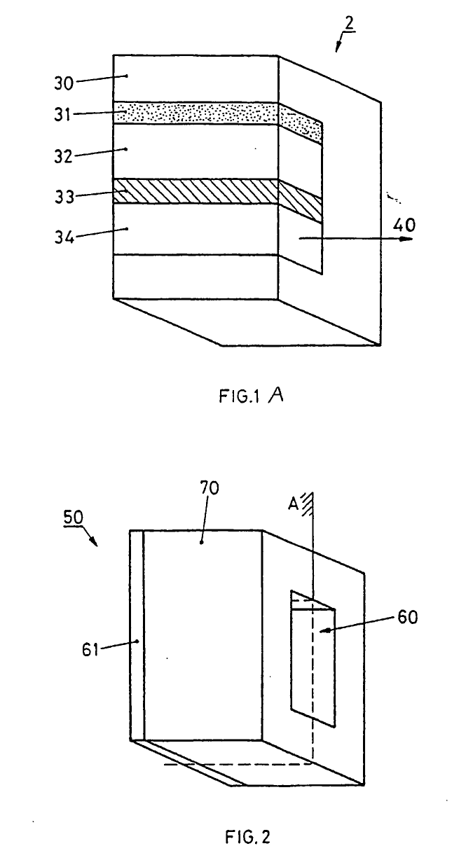

In FIG. 1A, a laser unit 2 according to the invention is illustrated. This is a semiconductor laser unit based for example on gallium arsenide. Laser unit 2 according to the invention is distinguished by high target accuracy. It is possible, for example, to generate wavelengths from 400 nm to 700 nm using laser unit 2 according to the invention.

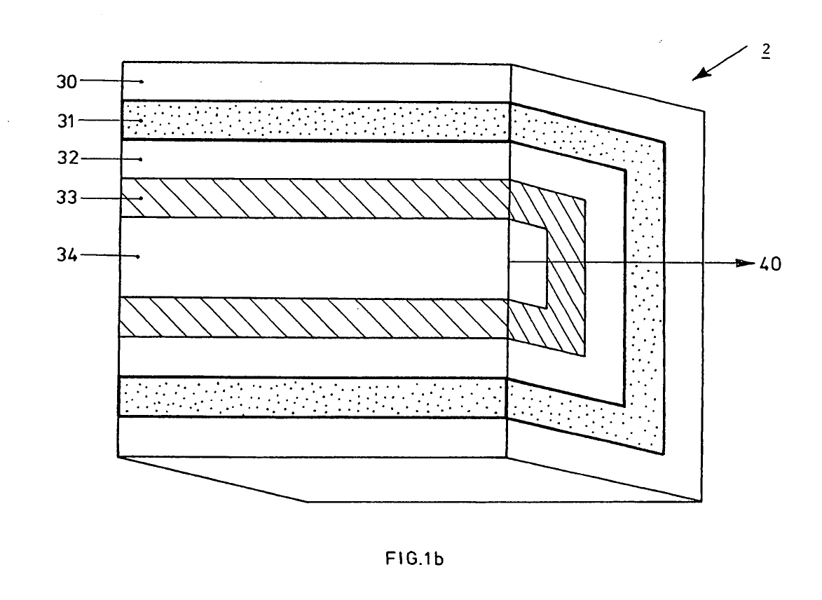

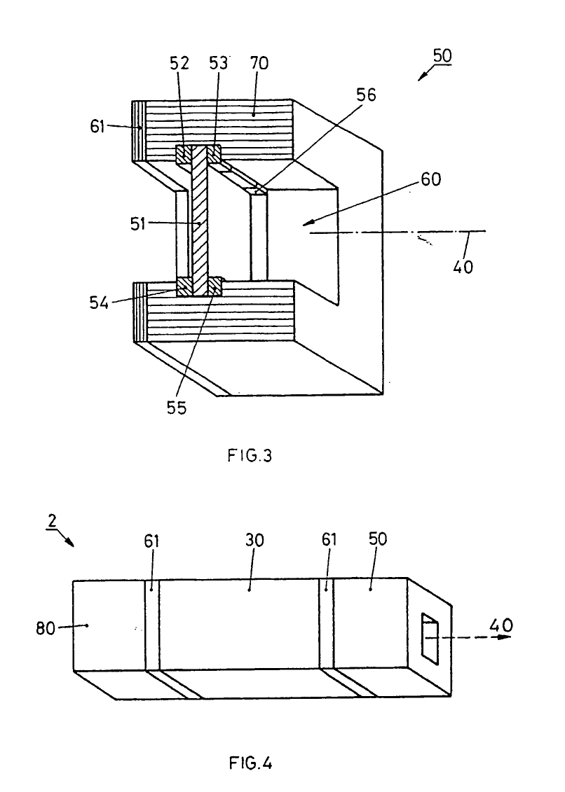

FIG. 1A depicts the schematic structure of a part of laser unit 2 with reference to a section parallel to a longitudinal axis 40. The light waves generated as laser beams propagate parallel to longitudinal axis 40; a mirror unit and an exit window, which is implemented as a semitransparent window, are not illustrated in FIG. 1A but are explained with reference to FIGS. 2 and 3. The semitransparent window can also be, for example, a so-called Brewster window.

A support unit 30, which is made of a solid, heat-conducting material, for example brass or platinum, and can be regarded as a housing part, encloses a core proper of laser unit 2, specifically a laser diode unit 34, in which laser beams are generated in the junction region between rhw p-layer and n-layer in a fashion known in the case of semiconductor lasers. The layer designated as laser diode unit 34 is, according to FIG. 1, located directly on support unit 30. There follow, starting from laser diode unit 34, a first insulation layer 33, a piezoelement 32 as a pressure-generating element, and a second insulation layer 31, which is in contact on its other side with enclosing support unit 30. In this way, piezoelement 32 is electrically insulated.

With the previously described structure of laser unit 2, it is now possible, through a force generated in piezoelement 32, to act on laser diode unit 34 in order in this way to alter the wavelength, since the spacing between the valence band and the conduction band—and thus the wavelength—is dependent on the force acting on laser diode unit 34.

Piezoelement 32 is preferably fabricated from a tourmaline crystal provided with a silver film on its surface, which film was generated by evaporation and is employed for contacting and thus controlling the entire piezoelement 32. In place of a silver film, aluminum or another metal film can also be applied by evaporation.

As has already been explained, generating a laser beam with laser unit 2 requires both a mirror unit and also an exit window, which are arranged substantially transversely to longitudinal axis 40 of laser unit 2 (FIG. 1A or 1B). While the rear mirror reflects the light beams generated by laser diode unit 34 as totally as possible, the exit window has the task of allowing light beams that satisfy predetermined conditions to escape from laser unit 2—right through the semitransparent window. Further information can be found in the publication “Understanding Lasers” by Jeff Hecht (pages 110 and 111, Second Edition, IEEE Press, New York, 1992).

A further embodiment of a part of laser unit 2 is illustrated in FIG. 1B with reference to a section parallel to a longitudinal axis 40, analogously to FIG. 1A. As already in the embodiment according to FIG. 1A, support unit 30 of the embodiment according to FIG. 1B also forms a cavity in which there are contained two insulation layers 31 and 33, a piezoelement 32 and a laser diode unit 34. In contrast to the variant embodiment according to FIG. 1A, laser diode unit 34 is initially enclosed by first insulation layer 33, next by piezoelement 32 as a pressure-generating element, then by second insulation layer 31, and finally by support unit 30. In this way it is possible to generate with pressure-generating element 32 a force that acts on laser diode unit 34 from all radial directions, that is, substantially perpendicularly to longitudinal axis 40.

Illustrated in FIG. 2 is an exit window 50 as it is arranged axially on support element 30 illustrated in FIG. 1. Exit window 50 essentially comprises a frame element 70 and a laterally arranged insulation layer 61, an opening 60 being provided both through frame element 70 and through insulation layer 61. Also drawn in FIG. 2 is a cutting plane A-A, which forms the basis for the section through the exit window 50 illustrated in FIG. 3.

FIG. 3 depicts exit window 50, illustrated in FIG. 2, in section along cutting plane A-A (FIG. 2). Through the section parallel to longitudinal axis 40, frame element 70 becomes a U-shaped part into which there is inserted a semitransparent window 51, which stands substantially perpendicular to the propagation direction, that is, to longitudinal axis 40. A displacement of semitransparent window 51, both translationally in the axial direction and also as a tilting movement about longitudinal axis 40, is achieved with the aid of positioning elements 52 to 56 (also referred to more generally as displacement elements in what follows), which in turn are fashioned as piezoelements. So that there will be three degrees of freedom for the movements of semitransparent window 51, positioning elements 52 to 56 in the embodiment illustrated in FIG. 3 are arranged at the corners of four-cornered semitransparent window 51. Further, positioning elements 52 to 56 are individually contacted via an electrical connection so that positioning elements 52 to 56 can be driven independently of one another. Control takes place for example via a central control unit, which is not further illustrated.

The mirror unit, which is to reflect the light beams generated in laser diode unit 34 (FIG. 1) in as total and loss-free a manner as possible, can be implemented as a fixed mirror surface in accordance with the known art.

In a further embodiment of the invention it is proposed to implement the mirror unit not as fixed, but analogously to semitransparent window 51, explained with reference to FIGS. 2 and 3. In this variant embodiment, to be sure, no semitransparent window is necessary. For this reason, in place of semitransparent window 51 illustrated in FIG. 3, what is needed is a reflective surface that is obtained for example by evaporating a metal film onto a support. The remaining elements, that is, the positioning or displacement elements, are employed for controlling the reflective surface. In this way there is created a laser unit 2 that exhibits an application range expanded relative to the embodiment having a fixed mirror surface (mirror element), as will become particularly clear in light of the discussion that follows.

In order to obtain a resonance in a laser unit, it is known to be of decisive importance that the spacing between the mirror surface (mirror element) and the semitransparent window be a multiple of, or exactly equal to, half the wavelength of interest (λ/2). If now, according to the present invention, the wavelength is altered by alteration using piezoelement 32 (FIG. 1), then an efficient laser unit (i.e., maximally coherent light) can be obtained above all when the spacing between the mirror surface and semitransparent window 51 is set as a multiple of, or equal to, half the wavelength of interest.

It has been found that, through the combination of force exertion on laser diode unit 34 from all sides (FIG. 1B) and the simultaneously performed correct setting of the spacing between the mirror surface and semitransparent window 51, there is made available a laser unit 2 (FIG. 1) having extreme versatility of setting, which is distinguished in particular in that the wavelength can be set electrically between, for example, 400 nm and 700 nm without the need for prisms or chromatic filters or, without the need to perform frequency doubling.

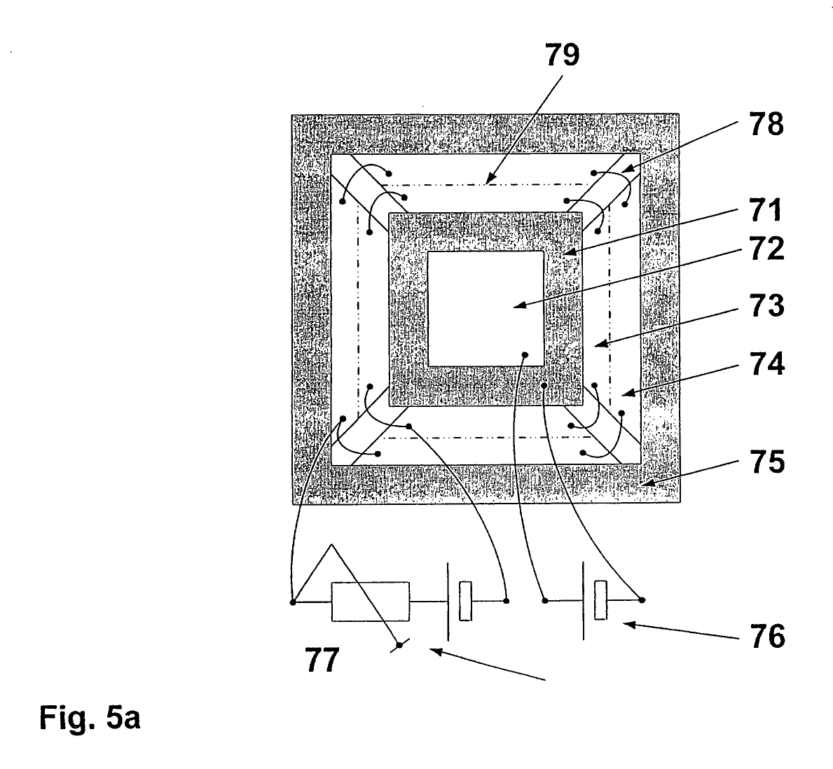

FIG. 4 depicts laser unit 2 comprising the individual parts explained with reference to FIGS. 1A, 1B, 2, and 3. Thus support element 30 according to FIG. 1 is arranged between frame element 50 having the semitransparent window and a mirror unit 80, an insulation layer 61 being present for electrical and thermal insulation between individual parts 80, 30, and 56.

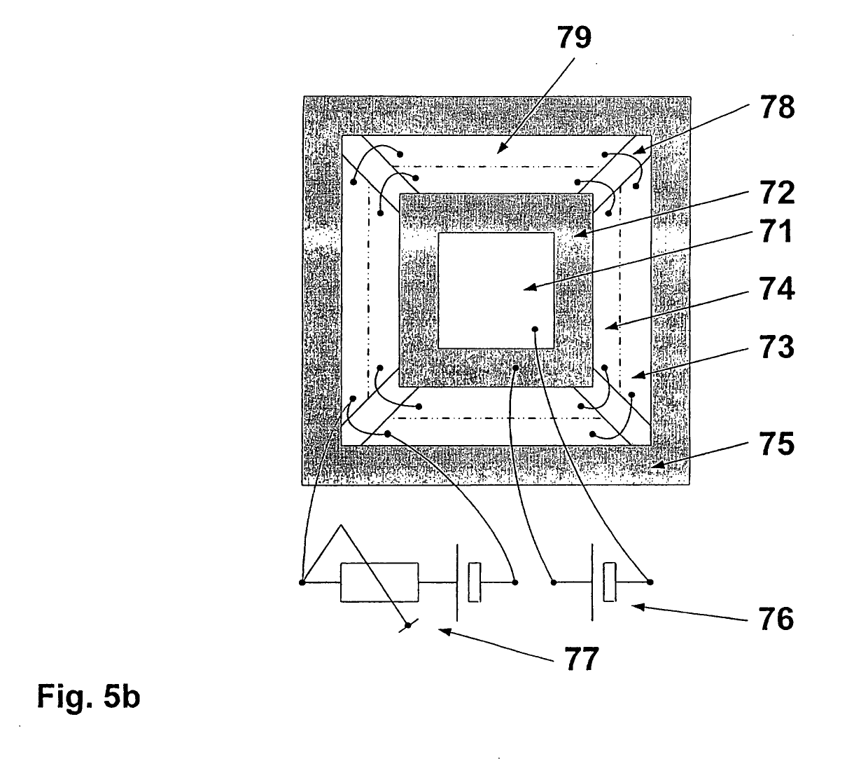

FIGS. 5A and 5B depict laser diode units fabricated by epitaxy or also by other methods, which laser units exhibit pressure-generating elements 73, 74 on all four sides of the square cross section, the four parts of pressure-generating elements 73, 74 being spaced apart at each of the corners. In order to actuate all four parts of pressure-generating elements 73, 74 simultaneously, these are electrically connected to one another with the aid of bond wires (as illustrated in FIGS. 5A and 5B) or directly coupled to a voltage source or, respectively, control unit 77 provided for this purpose.

For further clarification, a p-n junction is illustrated in FIG. 5A and an n-p junction in FIG. 5B for the laser diode unit. From FIGS. 5A and 5B it is apparent that the pressure-generating elements 73, 74 exhibit opposite poles relative to the laser diode unit, so that a mutually unfavorable influence between pressure-generating element and laser diode unit can be prevented.

The reference characters employed in FIGS. 5A and 5B can be identified as follows:
71 n (cathode) of laser diode unit;
72 p (anode) of laser diode unit;
73 n terminal of pressure-generating element;
74 p terminal of pressure-generating element;
75 support element;
76 source for the laser diode unit;
77 control circuit for setting the force acting on the laser diode unit;
78 air gap between the individual parts of the pressure-generating unit;
79 pressure-generating element.

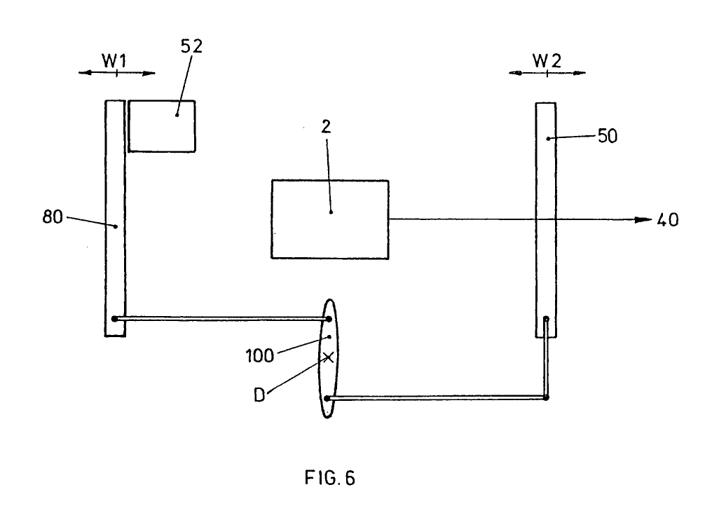

In schematic representation, FIG. 6 depicts a device according to the invention, having laser unit 2 arranged centrally between mirror unit 80 and exit window 50, which laser unit is implemented, for example, in the fashion described in connection with FIGS. 5A and 5B. This embodiment is distinguished in that both the mirror unit 80 and the exit window 50 are displaced in dependence on the force generated by the pressure-generating element (not illustrated in FIG. 6) and acting on the laser diode unit, and specifically in such fashion that the laser diode unit is always located centrally between mirror unit 80 and exit window 50 or, respectively, the diode laser facet is half the wavelength or a multiple of half the wavelength away from the mirror unit, this being dependent on whether the diode laser facet is antireflection-coated or not. Specifically, if the diode laser facet is antireflection-coated, no additional resonance builds up between the diode laser facet and the mirror unit. If, on the other hand, the diode laser facet is not antireflection-coated, then an additional resonance builds up between the diode laser facet and the mirror unit, leading to additional waves and thus to a loss if the distance is incorrect. This is with deviations depending on the distance of the mirror units relative to the diode laser facet and applies to both exit ends of the laser diode unit. This is achieved, for example, with the aid of the synchronous rotation device 100 illustrated in FIG. 6, which is rotatably mounted at point D. If now mirror unit 80 is displaced with displacement element 52 in a direction W1, a 1:1 transmission to exit window 50 takes place via synchronous rotation device 100, so that the exit window experiences a displacement of identical magnitude in direction W2.

As an additional advantage, central alignment of the laser diode unit or respectively its facet yields optimized power utilization.

In place of synchronous rotation device 100, there can of course be two or a plurality of displacement elements 52 that are matched and arranged in such fashion that the laser diode unit is always located centrally between the mirror unit 80 and exit window 50.

1. Light unit for generating light beams having various wavelengths, including
a light source unit (34),
a mirror unit (80),
a support unit (30),
an exit window (50) having an opening (60), and
a pressure-generating element (32),
the light source unit (34) and the pressure-generating element (32) being contained in the support unit (30), which exhibits a longitudinal axis (40) running substantially parallel to the generated light beams, the mirror unit (80) and the exit window (50) being arranged on opposite ends of the support unit (30), and a force being generated with the pressure-generating element (32), which force acts on the light source unit (34), wherein at least one of the mirror unit (80) and the exit window (50) is at least one of displaceable relative to the support unit (30) and tiltable relative to the longitudinal axis (40) by at least one displacement element (52, . . . , 55) in dependence on the force generated by the pressure-generating element (32) on the light source unit (34).

2. Light unit according to claim 1, wherein a force on the light source unit (34) can be generated from a plurality of sides with the pressure-generating element (32), the force acting substantially perpendicularly to the longitudinal axis (40).

3. Light unit according to claim 1, wherein a force, uniform all around, can be generated on the light source unit (34) with the pressure-generating element (32).

4. Light unit according to claim 1, wherein the pressure-generating element (32) is of piezoelement type, based on a material selected from the group consisting of sodium persulfate, sodium hydroxide, and copper sulfate.

5. Light unit according to claim 4, wherein the piezoelement (32) is a tourmaline crystal that has an electrically conductive film selected from the group consisting of silver and aluminum for contacting on the sides facing toward and away from the light source unit (34).

6. Light unit according to claim 1, wherein the exit window (50) is selected from the group consisting of a semitransparent window and a Brewster window (51).

7. Light unit according to claim 1, wherein the exit window (50) and the mirror unit (80) are displaceable in such fashion that the light source unit (34) is always arranged centrally between the exit window (50) and the mirror unit (80).

8. Light unit according to claim 1, wherein the displacement element comprises at least one piezoelement (52, . . . , 56).

9. Light unit according to claim 1, further comprising an insulation layer (61) between the mirror unit (80) and the support unit (30) and between the exit window (50) and the support unit (30).

10. Light unit according to claim 1, wherein the light source unit is a laser diode unit (34) of the semiconductor laser type.

11. Method for generating light beams having various wavelengths through the use of a light unit including
a light source unit (34),
a mirror unit (80),
a support unit (30),
an exit window (50) having an opening (60), and
a pressure-generating element (32),
the light source unit (34) and the pressure-generating element (32) being contained in the support unit (30),
which has a longitudinal axis (40) running substantially parallel to the generated light beams, the mirror unit (80) and the exit window (50) being arranged at opposite ends of the support unit (30), a force acting on the light source unit (34) being generated with the pressure-generating element (32), and the method comprising displacing at least one of the mirror unit (80) and the exit window (50) relative to the support unit (30) and tilting said at least one of said mirror unit and exit window relative to the longitudinal axis (40) by at least one displacement element (52, . . . , 56) in dependence on the force generated by the pressure-generating element (32) on the light source unit (34).

12. Method according to claim 11, including generating said force on the light source unit (34) from a plurality of sides with the pressure-generating element (32), the force acting substantially perpendicularly to the longitudinal axis (40).

13. Method according to claim 11, wherein said force generated on the light source unit is uniform all around.

14. Method according to claim 11, including displacing the exit window (50) and the mirror unit (80) in such fashion that the light source unit (34) is always arranged centrally between the exit window (50) and the mirror unit (80).

15. Method according to claim 11, including setting the spacing between the mirror unit (80) and the exit window (50) such that the distance of said spacing is exactly equal to, or a multiple of, half the wavelength of interest.
